(19) United States
(12) Patent Application Publication
(10) Pub. No.: US 2006/0017652 A1
(43) Pub. Date: Jan. 26, 2006

(54) Control apparatus of display device, control method and electronic apparatus

(75) Inventors: Toshiro Obitsu, Kawasaki (JP); Hisamichi Higuchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/236,626

(22) Filed: Sep. 28, 2005

Related U.S. Application Data
(63) Continuation of application No. PCT/JP03/06870, filed on May 30, 2003.

(51) Int. Cl. G09G 5/00

(52) U.S. Cl. 345/3.1

(57) ABSTRACT

A control apparatus for controlling a display device for displaying information on a screen by repeating a scan period when a signal scans the screen and a non-scan period from the end of the scan period to the start of the next scan period. The control apparatus includes a processor for processing information to be displayed on the display device, a clock generator for defining the operation speed of the processor, a switch section for switching the clock frequency of the clock generated in the clock generator, and a synchronization controller for synchronizing the clock frequency switching by the switch section with the non-scan period.

### CROSS-REFERENCE TO RELATED APPLICATIONS

This is a continuation of International Application PCT/JP2003/006870, filed on May 30, 2003. The disclosures of International Application PCT/JP2003/006870 including the specification, drawings and abstract are incorporated herein by reference.

### BACK GROUND OF THE INVENTION

1. Technical Field

The present invention relates to display control in an information processing device.

2. Background Arts

A system structure of an information processing device has been diversified over the recent years. For example, in a personal computer, there is a system that does not include a dedicated video memory but shares a main memory. In this type of system, without being provided with an arbitrating function by a memory controller, a video controller accesses the main memory via a processor (CPU) and thus performs displaying on a screen.

If the personal computer having such a configuration, however, adopts a power saving function based on changing a CPU clock, the following problems arise. Namely, the CPU clock changes when the personal computer changes over to a power saving mode, and therefore the CPU clock temporarily stops with the result that the CPU similarly stops. Hence, there stops accessing the main memory (corresponding to the video memory) from the video controller via the CPU. That is, during a stop period of the CPU, the video memory becomes unaccessible from the video controller, and information such as an image can not be normally displayed on the screen. Accordingly, a flickering phenomenon occurs on the screen each time the personal computer shifts to the power saving mode. This sort of phenomenon causes cases where a user has an unpleasant feeling and mistakenly recognizes that the device gets into a fault.

For others, technologies disclosed in Patent document 1 and Patent document 2 are given as technologies related to the present invention.

[Patent Document 1]

Japanese Patent Application Laid-Open Publication No. 7-162784
   [Patent Document 2]
Japanese Patent Application Laid-Open Publication No. 7-44284

### SUMMARY OF THE INVENTION

The present invention aims at solving the problems described above and providing a technology capable of reducing a flicker on a display screen even when an information device having no video memory shifts to a power saving mode.

For obviating the aforementioned problems takes the following configurations. Namely, the present invention is a control apparatus controlling a display device that displays information on a screen by repeating a scan period for scanning a signal over the screen and a non-scan period extending from an end of the scan period to a start of the next scan period, the control apparatus comprising a processing unit processing the information to be displayed on the display device, a clock generation unit specifying an operation speed of the processing unit, a change unit changing a clock frequency of a clock generated by the clock generation unit, and a synchronization control unit synchronizing the change of the clock frequency by the change unit with the non-scan period.

Preferably, the control apparatus may be constructed in a way that further comprises a storage unit having a function of a video memory for storing information corresponding to the display on the screen in a way of being controlled by the processing unit, and an image transfer unit reading the information stored on the storage unit and transferring the information to the display device.

The synchronization control unit of the control apparatus may be constructed in a way that further includes a detection unit detecting the scan period or the non-scan period of the display device.

The control apparatus may be constructed in a way that further comprises a second detection unit detecting the scan-period or the non-scan period of other display device, wherein the synchronization control unit synchronizes the change of the clock frequency by the change unit with an overlapped period of the non-scan period of the display device and the non-scan period of the other display device.

According to the present invention, the control apparatus can change to a power saving mode simultaneously with a rewrite timing of the display device. It is therefore possible to reduce the flicker occurred on the screen on the display device when the device shifts to the power saving mode. Thus, causes by which a user has an unpleasant feeling and mistakenly recognizes that the device gets into a fault, can be decreased by reducing the flicker on the screen on the display device.

Furthermore, the present invention is an electronic apparatus comprising a display unit displaying information on a screen by repeating a scan period for scanning a signal over the screen and a non-scan period extending from an end of the scan period to a start of the next scan period, a processing unit processing the information to be displayed on the display unit, a clock generation unit specifying an operation speed of the processing unit, a change unit changing a clock frequency of a clock generated by the clock generation unit, and a synchronization control unit synchronizing the change of the clock frequency by the change unit with the non-scan period.

Preferably, the electronic apparatus may be constructed in a way that further comprises a storage unit having a function of a video memory for storing information corresponding to the display on the screen in a way of being controlled by the processing unit, and an image transfer unit reading the information stored on the storage unit and transferring the information to the display unit.

Preferably, the synchronization control unit of the electronic apparatus may be constructed in a way that further includes a detection unit detecting the scan period or the non-scan period of the display unit.

Preferably, the electronic apparatus may be constructed in a way that further comprises other display unit and a second detection unit detecting the scan-period or the non-scan period of the other display unit, wherein the synchronization control unit synchronizes the change of the clock frequency by the change unit with an overlapped period of the non-scan period of the display unit and the non-scan period of the other display unit.

According to the present invention, the electronic apparatus can change to the power saving mode simultaneously with the rewrite timing of the display unit. It is therefore feasible to decrease the flicker occurred on the display unit when the electronic apparatus shifts to the power saving mode. Herein, the electronic apparatus is, for example, a notebook type personal computer constructed including the display unit. Thus, in the electronic apparatus also, the causes by which the user has the unpleasant feeling and mistakenly recognizes that the electronic apparatus gets into the fault, can be decreased by reducing the flicker on the screen on the display unit thereof.

The present invention may also be a method of executing any one of the processes described above when the control apparatus or the electronic apparatus shifts to the power saving.

### BRIEF DESCRIPTION OF THE DRAWINGS

FIG. 1 is a diagram of a system architecture of a personal computer in an embodiment for actualizing the present invention;

FIG. 2 is a diagram showing internal configurations of a VGA and a chipset shown in FIG. 1; and

FIG. 3 is a flowchart showing processes executed by a personal computer when shifting to power saving.

### DETAILED DESCRIPTION OF THE INVENTION

An embodiment of the present invention will hereinafter be described with reference to the drawings. Note that an explanation of the present embodiment is an exemplification, and the configuration of the present invention is not limited to the following description.

### Embodiment

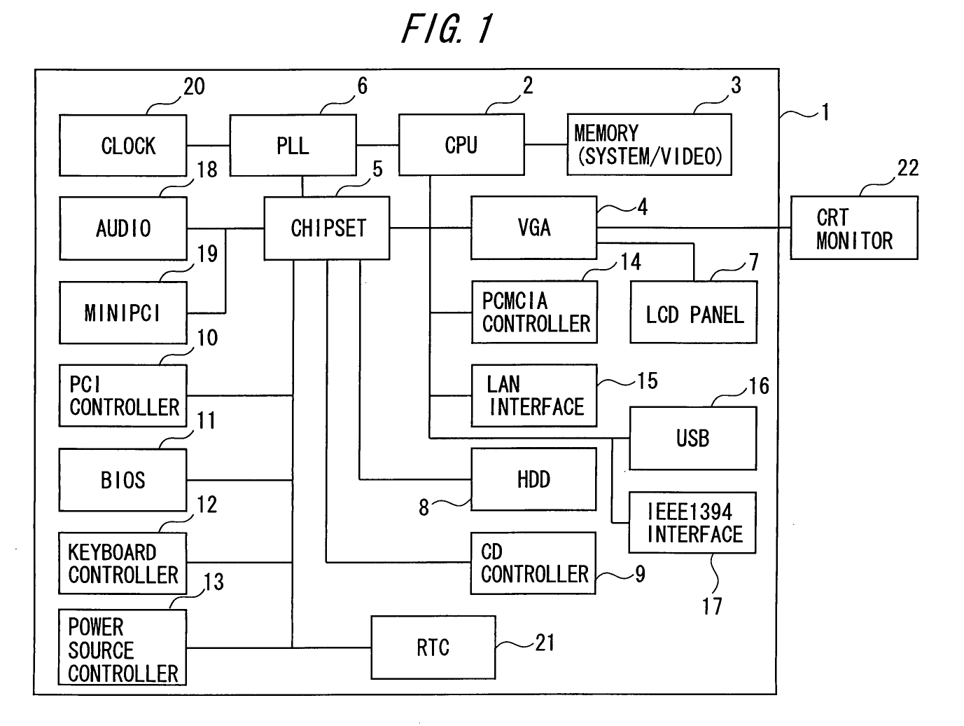

Next, an embodiment for actualizing the present invention will be described with reference to FIGS. 1 through 3.

<System Architecture>

A system architecture of a personal computer in the embodiment for actualizing the present invention will be explained. FIG. 1 is a diagram of the system architecture of the personal computer in the embodiment for actualizing the present invention. The discussion on the system architecture of the personal computer will hereinafter be focussed on functions related to the present embodiment.

A personal computer 1 is constructed in a way that includes a processor (CPU) 2, a memory 3, a VGA (Video Graphics Array) 4, a chipset 5, a PLL (Phase Locked Loop) 6, a display device (LCD (Liquid Crystal Display) panel) 7, a hard disc drive (HDD) 8, a variety of control units, a variety of interface units, and an audio unit 18. Further, a CRT monitor 22 serving as a display device can be externally connected to the personal computer 1.

The CPU 2, which is connected via a bus respectively to the memory 3 for storing data, the PLL 6 for generating clocks and the interface units for connecting multiple lines and peripheral devices, controls the respective functions and executes internal processes. The interface units are constructed in a way that includes a LAN interface 15, a USB (Universal Serial Bus) 16, an IEEE1394 interface 17, and a PCMCIA (Personal Computer Memory Card International Association) controller 14 for controlling a PCMCIA interface.

The chipset 5 is connected via the bus respectively to the VGA 4 controlling display on a screen, the PLL 6 generating the clocks and driving the CPU 2, the HDD 8 reading the HDD etc. and the variety of control units. The chipset 5 controls the respective units given above in linkage with the CPU 2. Further, the VGA 4 connects via the bus respectively to the LCD panel 7 employing a liquid crystal and the CRT monitor 22 using a CRT (Cathode Ray Tube (Braun tube)). A clock 20 generates a clock serving as a basis in the system. Further, the PLL 6 is connected via the bus to the clock 20 and generates a CPU clock.

The variety of control units described above are, for instance, a CD controller 9 controlling CD (Compact Disc) media, a PCI (Peripheral Component Interconnect) controller 10 controlling an internal bus, a BIOS (Basic Input/Output System) 11 controlling a variety of devices connected thereto, a keyboard controller 12 controlling a keyboard, a power source controller 13 controlling a power supply, and so forth. Further, the power source controller 13 is connected via the bus to a RTC (Real Time Clock) 21 that performs clocking.

The audio unit 18 is connected to the chipset 5 via a mini PCI 19 as a small-sized bus, and executes voice-related processing.

<Internal Configurations of VGA and Chipset>

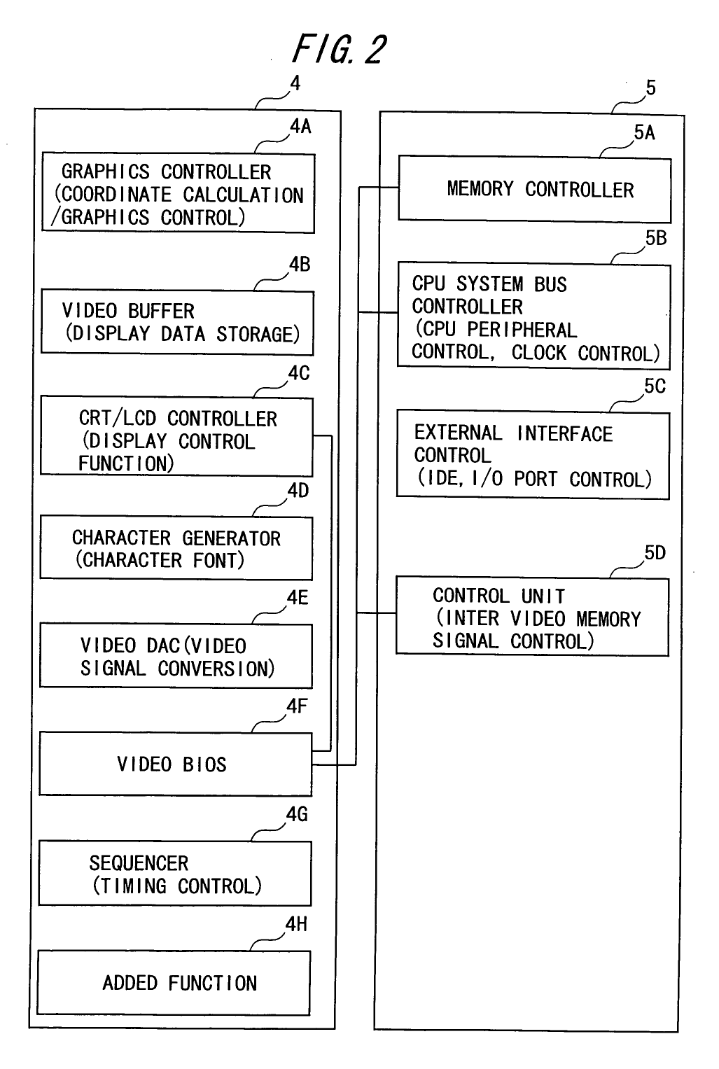

Next, respective internal configurations and related operations of the VGA 4 and the chipset 5 will be explained. FIG. 2 is a diagram showing the internal configurations of the VGA 4 and the chipset 5 shown in FIG. 1.

To start with, the internal configuration of the VGA 4 will be explained. The VGA 4 includes a graphics controller 4A that conducts coordinate calculations or graphics control, a video buffer 4B stored with display data, a CRT/LCD controller 4C functioning so as to control the display on the screen, a character generator 4D controlling character fonts displayed on the screen, a video DAC (Digital/Analog Converter) 4E converting the data displayed on the screen into analog signals from digital signals, a video BIOS 4F controlling a video output device connected thereto, a sequencer 4G controlling a timing when controlling a display size, and an added function 4H (e.g., a function of S-video (Separate Video)).

The CRT/LCD controller 4C is connected to the display devices (which are the LCD panel 7 and the CRT monitor 22 in FIG. 1). The CRT/LCD controller 4C has, specifically, a register showing a state of the display device.

Next, the internal configuration of the chipset 5 will be explained. The chipset 5 includes a memory controller 5A, a CPU system bus control 5B controlling peripheral functions of the CPU (which controls, e.g., the PLL 6 for driving the CPU), an external interface control 5C controlling IDE (Integrated Drive Electronics) and an input/output port, and a control unit 5D controlling signals between the video memory and the chipset 5.

Subsequently, the related operation based on the internal configurations of the VGA 4 and the chipset 5 will be described. The VGA 4 and the chipset 5 function in linkage when connected via the bus and displaying the information on the screen. The memory controller 5A, the CPU system bus control 5B and the control unit 5D provided in the chipset 5 are connected to the video BIOS 4F provided in the VGA 4. The video BIOS 4F is connected to the CRT/LCD controller 4C (register) in which to set a flag for distinctively showing whether the display device is at display time or not. Whether the display device is at the display time or not is set based on a signal for driving the display device. The display device displays the information such as an image on the screen by scanning the signal in crosswise directions. At this time, the screen is rewritten on a frame-by-frame basis (wherein one frame corresponds to one (divided) screen), and a vertical synchronizing signal changes at a screen-rewrite timing. A generation frequency of this vertical synchronizing signal is termed a vertical synchronizing frequency. The VGA 4 sets a state of the display screen as “0” or “1” in a flag on the basis of the vertical synchronizing signal. For instance, in a device where the vertical synchronizing signal continues up to a start of the next frame, a vertical synchronizing signal generation timing may be set as “1” in the flag. Further, “1” may be set in the flag when generating the vertical synchronizing signal, and “0” may also be set in the flag when generating a first horizontal synchronizing signal in the next first line. This contrivance enables the chipset 5 to recognize from the information set in the flag whether it is just at a display screen change timing or not.

<Operation>

Next, an operation will be explained by exemplifying a case in which the LCD panel 7 and the CRT monitor 22 are connected as the display devices to the personal computer 1.

The VGA 4 stores the register (CRT/LCD controller 4C) with information showing vertical synchronizing time based on signals detected from the LCD panel 7 and from the CRT monitor 22. The chipset 5 recognizes display states on the LCD panel 8 and on the CRT monitor 22 from the register of the VGA 4. At this time, the chipset 5 detects the time when the CPU clock synchronizes simultaneously with vertical synchronizing time of the LCD panel 7 and the CRT monitor 22. The chipset 5 outputs a reset signal to the PLL 6 at a timing when the CPU clock synchronizes simultaneously with the vertical synchronizing time of the LCD panel 7 and the CRT monitor 22. The PLL 6 changes an operation frequency of the CPU clock for the CPU 2 as triggered by the reset signal from the chipset 5. Namely, a shift to a power saving mode requires changing the CPU clock. Thus, the personal computer 1 can change the CPU clock in synchronization with the vertical synchronizing time of the display devices (the LCD panel 7 and the CRT monitor 22).

<Processing Flow>

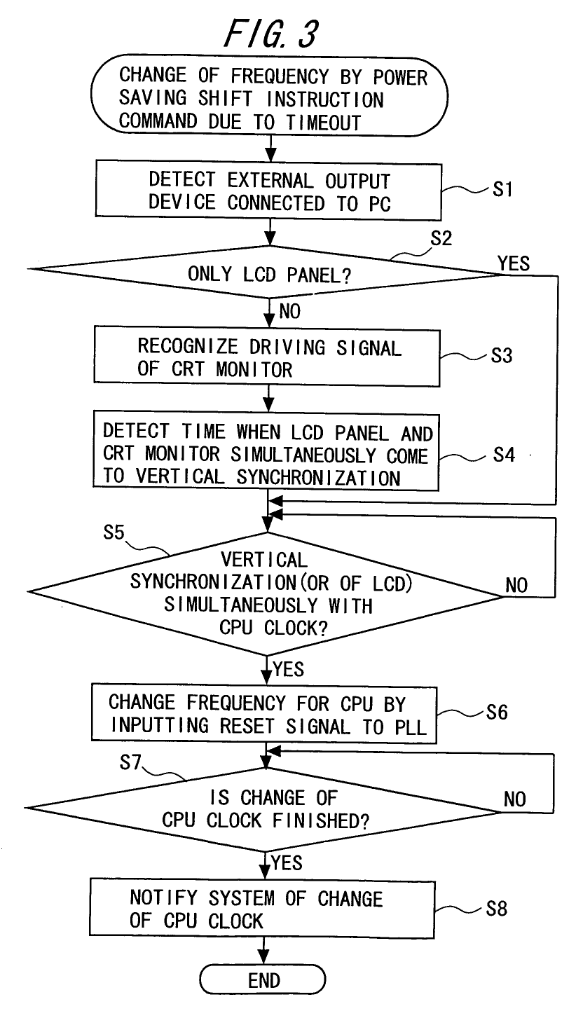

Next, processes executed by the personal computer 1 when shifting to the power saving will be explained. FIG. 3 is a flowchart showing the processes executed by the personal computer 1. These processes are executed as triggered by a timing when the personal computer 1 changes over to the power saving mode. This process executed mainly in the chipset 5.

At first, the chipset 5 detects the display devices connected to the personal computer 1 (S1). In the example of the system architecture shown in FIG. 1, the LCD panel 7 and the externally-connected CRT monitor 22 are detected as the display devices. The discussion will hereinafter proceed on the assumption that the LCD panel 7 and the CRT monitor 22 are detected as the display devices.

Subsequently, the chipset 5 judges whether the detected display device is only the LCD panel 7 or not (S2). If the display device other than the LCD panel 7 is connected (if the display device is externally connected), the chipset 5 recognizes the signal for driving this connected display device (S3). In the example of the system architecture shown in FIG. 1, the chipset 5 recognizes the driving signal of the CRT monitor 22. The LCD panel 7 is the function provided directly in the personal computer, and therefore the driving signal of the LCD panel 7 is automatically recognized. Then, the time when the signals from the CRT monitor 22 and from the LCD panel 7 are simultaneously vertically synchronized, is detected (S4). At this time, the vertical synchronizing time is distinctively known from the flag (value) set in the register (the CRT/LCD controller 4C) of the VGA 4. While on the other hand, if the connected display device is only the LCD panel 7, the operation proceeds to processes from S4 onward.

Subsequently, it is judged whether or not there is time (timing) at which the time when the LCD panel 7 and the CRT monitor 22 simultaneously come to the vertical synchronization, synchronizes with the CPU clock (S5). Namely, a timing at which the time when the LCD panel 7 and the CRT monitor 22 simultaneously come to the vertical synchronization synchronizes with the CPU clock, is detected. If there is the time (timing) of synchronizing with the CPU clock, the chipset 5 outputs the reset signal to the PLL 6 so as to get coincident with this timing (S6). The PLL 6, upon the input of the reset signal from the chipset 5, changes the frequency for the CPU 2. Namely, the PLL 6 generates a clock having a different frequency in order to drive the CPU 2 in the power saving mode. Then, the thus-generated clock (the CPU clock) is outputted to the CPU 2. The CPU clock may be generated by, for example, setting a speed mode in the PLL 6 and changing the speed mode in accordance with the input of the reset signal. More specifically, a frequency for a high-speed mode and a frequency for a low-speed mode are set as the speed mode, and, if the reset signal is inputted during the high-speed mode, the clock may be outputted to the CPU 2 on the basis of the frequency for the low-speed mode.

The chipset 5 recognizes whether a process of changing the CPU clock is terminated or not (S7). In the case of recognizing that the process has been terminated, the chipset 5 outputs a signal for notifying the systems such as OS (Operating System) and the driver that the CPU clock has been changed (S8). Thus, the personal computer 1 changes the CPU clock for the CPU 2 when the display device is not at the display time (the vertical synchronizing time).

According to the present embodiment, the change to the power saving mode can be done simultaneously with the change timing of the display screen on the display device, and hence a flicker occurred on the display screen when shifting to the power saving mode can be reduced.

<Modified Example>

The assumption in the embodiment discussed above is the case where the two display devices such as the LCD panel 7 and the CRT monitor 22 are connected to the personal computer 1. The embodiment of the present invention is not limited to the display device. For instance, there may be such a case that only the LCD panel is connected and may also be a case in which only the CRT monitor is connected.

Moreover, in the embodiment discussed above, when shifting to the power saving mode, the display screen is changed over by detecting the time (timing) when the signal for driving the display device reaches the vertical synchronization. The embodiment of the present invention is not, however, limited to the signal taking the change timing of the display screen. Another available configuration is, for example, that the display screen is changed over by detecting time (timing) when the signal for driving the display device comes to horizontal synchronization.

### INDUSTRIAL APPLICABILITY

The present invention can be applied to systems in which the devices include none of the video memories.

What is claimed is:

1. A control apparatus controlling a display device that displays information on a screen by repeating a scan period for scanning a signal over the screen and a non-scan period extending from an end of the scan period to a start of the next scan period, said control apparatus comprising:
a processing unit processing the information to be displayed on said display device;
a clock generation unit specifying an operation speed of said processing unit;
a change unit changing a clock frequency of a clock generated by said clock generation unit; and
a synchronization control unit synchronizing the change of the clock frequency by said change unit with the non-scan period.

2. A control apparatus according to claim 1, further comprising:
a storage unit having a function of a video memory storing information corresponding to the display on the screen in a way of being controlled by said processing unit; and
an image transfer unit reading the information stored on said storage unit and transferring the information to said display device.

3. A control apparatus according to claim 1, wherein said synchronization control unit further includes a detection unit detecting the scan period or the non-scan period of said display device.

4. A control apparatus according to claim 3, further comprising a second detection unit detecting the scan-period or the non-scan period of other display device,
wherein said synchronization control unit synchronizes the change of the clock frequency by said change unit for an overlapped period of the non-scan period of said display device and the non-scan period of said other display device.

5. A control method in a control apparatus controlling a display device that displays information on a screen by repeating a scan period for scanning a signal over the screen and a non-scan period extending from an end of the scan period to a start of the next scan period, said control method comprising:
a change step changing a clock frequency of a clock that specifies an operation speed of said control apparatus; and
a synchronization control step synchronizing the change of the clock frequency by said change step with the non-scan period.

6. A control method according to claim 5, further comprising:
a storing step storing information corresponding to the display on the screen in a way of being controlled by said processing device; and
an image transferring step reading the information stored by said storing step and transferring the information to said display device.

7. A control method according to claim 5, further comprising a detecting step detecting the scan period or the non-scan period of said display device.

8. A control method according to claim 7, further comprising a second detecting step detecting the scan-period or the non-scan period of other display device,
wherein said synchronization control step includes synchronizing the change of the clock frequency by said change step with an overlapped period of the non-scan period of said display device and the non-scan period of said other display device.

9. An electronic apparatus comprising:
a display unit displaying information on a screen by repeating a scan period for scanning a signal over the screen and a non-scan period extending from an end of the scan period to a start of the next scan period;
a processing unit processing the information to be displayed on said display unit;
a clock generation unit specifying an operation speed of said processing unit;
a change unit changing a clock frequency of a clock generated by said clock generation unit; and
a synchronization control unit synchronizing the change of the clock frequency by said change unit with the non-scan period.

10. An electronic apparatus according to claim 9, further comprising:
a storage unit having a function of a video memory storing information corresponding to the display on the screen in a way of being controlled by said processing unit; and
an image transfer unit reading the information stored on said storage unit and transferring the information to said display unit.

11. An electronic apparatus according to claim 9, wherein said synchronization control unit further includes a detection unit detecting the scan period or the non-scan period of said display unit.

12. An electronic apparatus according to claim 11, further comprising other display unit and a second detection unit detecting the scan-period or the non-scan period of said other display unit,
wherein said synchronization control unit synchronizes the change of the clock frequency by said change unit with an overlapped period of the non-scan period of said display unit and the non-scan period of said other display unit.
